(19) United States
(12) Patent Application Publication
(10) Pub. No.: US 2007/0168888 A1
(43) Pub. Date: Jul. 19, 2007

(54) Method and software for navigation of data on a device display

(75) Inventor: Bjorn Jawerth, Morrisville, NC (US)

Correspondence Address: MORRISON & FOERSTER LLP, 1650 TYSONS BOULEVARD, SUITE 400, MCLEAN, VA, 22102, US

(73) Assignee: Summus, Inc., Raleigh, NC (US)

(21) Appl. No.: 11/723,733

(22) Filed: Mar. 21, 2007

Related U.S. Application Data
(63) Continuation of application No. 10/680,335, filed on Oct. 7, 2003, now abandoned.
(60) Provisional application No. 60/416,486, filed on Oct. 7, 2002.

(51) Int. Cl. G06F 3/048; G09G 5/08

(52) U.S. Cl. 715/857; 345/157; 715/856

(57) ABSTRACT

Preferred embodiments of the present invention comprise methods and software for providing a navigable, context-sensitive electronic display. A preferred embodiment comprises providing a cross hairs that consists of objects forming an intersection, each object corresponding to a different geometrical dimension of the display; communicating with an input device that provides signals to control movement of the cross hairs; and in response to signals received from said input device, configuring the cross hairs to point to a region on the display; wherein at least some data displayed on the display has an associated context; and wherein movement of the cross hairs on the display is based at least in part upon that context.

### CROSS-REFERENCE TO RELATED APPLICATIONS

This application is a continuation of U.S. application Ser. No. 10/680,335, filed Oct. 7, 2003, which claims priority of U.S. Provisional Application No. 60/416,486, filed Oct. 7, 2002, the contents of which are hereby incorporated herein by reference.

### BACKGROUND

A computer mouse allows a user to move a cursor or an arrow around a computer screen by sliding the computer mouse on a flat surface, usually a mouse pad. As the user moves the mouse, the cursor or the arrow follows the user's hand movements. When the user wants to select an object on the screen, he moves the cursor or the arrow to the object and then clicks, for example, on the left button of the 15 mouse. If the object identifies a file, a common shortcut is the ability to directly open the file in an application to which the file's type is associated, by clicking the mouse's left button twice in rapid succession. The right button on the mouse is usually used to retrieve information about the object chosen by the user.

Cross hairs, also known as cross wires, are used in many devices, including cameras, fighter jets, rifles, telescopes, etc. For instance, when a photographer looks through the viewfinder of his camera to compose a snapshot of a flower, a partially drawn cross hairs guide may be shown over the viewed image to help the photographer center his picture on the flower. In fighter jets and rifles, cross hairs are part of the targeting mechanism. The shooter uses the cross hairs to take aim at a target. A nice introduction about cross hairs in telescopes is at http://www.surveyhistory.org/cross-hairs.htm.

The problem addressed by the present invention is one faced by a mobile user who needs to navigate, access, retrieve and view data on his mobile device. The mobile user's interaction with his device may be hampered by a screen with small dimensions and low resolution. For example, a cell-phone user may be on a moving train using a map application on his phone and trying to trace the best route from the railway station to a restaurant of his choice. The user faces multiple problems:
(i) The typical cell-phone's display is small, limiting the amount of data visible to the user. Small displays with maximum resolutions less than 100 ×100 pixels are quite common on cell-phones.
(ii) Due to motion of the train, the user may find it difficult to focus on the cell-phone's screen in order to properly view the information on the map. For example, reading street names may be difficult in a moving train.
(iii) Navigation of the map displayed on his cell-phone is usually though directional keys or at best, a joystick mouse, making it difficult, for instance, to move from one part of the map to another.
(iv) Instead of browsing from one part of the map to another, the user may want to simply move from one landmark to another. In this case, the navigation device must be able to switch from a browsing mode to a landmark mode.
(v) The visual feedback to the user needs to be minimized. In this example, the user is only interested in plotting a route from the railway station to a restaurant. This information needs to be isolated from the other information displayed on the map.

It is, in part, to solving these kinds of problems that the present invention is directed.

### SUMMARY

The present invention comprises a method, system, and software for navigation of data on an electronic display. A preferred embodiment of the invention is referred to herein as the CrossPointerm™. The CrossPointer offers a new paradigm for the problem of navigation on a device's screen or in a window on the screen. Features include a preferred Cross Hairs Cursor or the use of the intersection of enhanced cross hairs to simplify the task of focusing on a point of interest on the screen and the movement by an input device of the cross hairs. The ability to turn on and off cross hairs and the use of multiple cross hairs are two of the optional features of the CrossPointer. Some of the more advanced features are context-driven navigation, marker creation, and information resolution. User scenarios and pictures are included in the detailed description of the preferred embodiments to better illustrate the features of the present invention.

Preferred embodiments of the present invention comprise methods and software for providing a navigable, context-sensitive electronic display. A preferred embodiment comprises providing a cross hairs that consists of objects forming an intersection, each object corresponding to a different geometrical dimension of the display; communicating with an input device that provides signals to control movement of the cross hairs; and in response to signals received from said input device, configuring the cross hairs to point to a region on the display; wherein at least some data displayed on the display has an associated context; and wherein movement of the cross hairs on the display is based at least in part upon that context.

In other aspects, the invention comprises a system and method to: (1) navigate, as well as access, retrieve, and view data, or a portion of the data using a Cross Hairs Cursor; (2) navigate data using the Cross Hairs Cursor where the intersection of the cross hairs points to the current region-of-interest on the device's screen; (3) navigate data using the Cross Hairs Cursor where data, or a portion of the data displayed on the device, has associated with it a meaning, or context; (4) navigate data using the Cross Hairs Cursor where the context is based on a discrete set of points or data or based on a connected set of points or data; (5) navigate data using the Cross Hairs Cursor where the data is in the form of markers or locations on the display; and (6) navigate data using the Cross Hairs Cursor where an information resolution method is supplemented to the basic data navigational system.

### BRIEF DESCRIPTION OF THE DRAWINGS

FIG. 1 depicts a class diagram for a preferred embodiment of the present invention.

FIG. 2 shows a preferred process of one embodiment.

FIG. 3 is a flowchart for steps of a preferred Context-driven Move.

FIG. 4 is a flowchart that contains the steps of a preferred Context-driven Update as well as examples of non-motion events for each of three types of contexts.

FIG. 5 depicts a preferred Cross Hairs Cursor with a triangle icon and with a rectangular box in the center.

FIG. 6 shows a preferred Cross Hairs Cursor with a circle in the center and with empty center.

FIG. 7 illustrates a preferred CrossPointer Cursor and the preferred CrossPointer Cursor with magnification box.

FIG. 8 depicts a preferred embodiment of the present invention with an information box showing hotel locations and one hotel detail.

FIG. 9 illustrates a preferred context-driven navigation mode and preferred default navigation mode of map data.

FIGS. 10-12 shows preferred steps in building a user-defined context using a preferred embodiment of the present invention.

FIG. 13 shows preferred Cross Hairs Cursor navigation of image data.

FIG. 14 depicts preferred Cross Hairs Cursor navigation of graphics data.

FIG. 15 illustrates a preferred Cross Hairs Cursor used with an image map.

### DETAIL DESCRIPTION OF PREFERRED EMBODIMENTS

In the following, we describe preferred embodiments of the systems and methods of the present invention. The CrossPointer™, a new and unique system for the navigation of data on a device display, is described in this document. First, basic features of the CrossPointer are described and then the more advanced features of the CrossPointer are outlined in detail. The basic features of the CrossPointer include, among others, a preferred Cross Hairs Cursor that makes it easy to locate a point of interest by pointing the intersection of the cross hairs to the specific data and controlling the movement of the cross hairs by arrow keys, stylus, and/or other input devices. Some of the more advanced features are context-driven navigation, marker creation and information resolution.

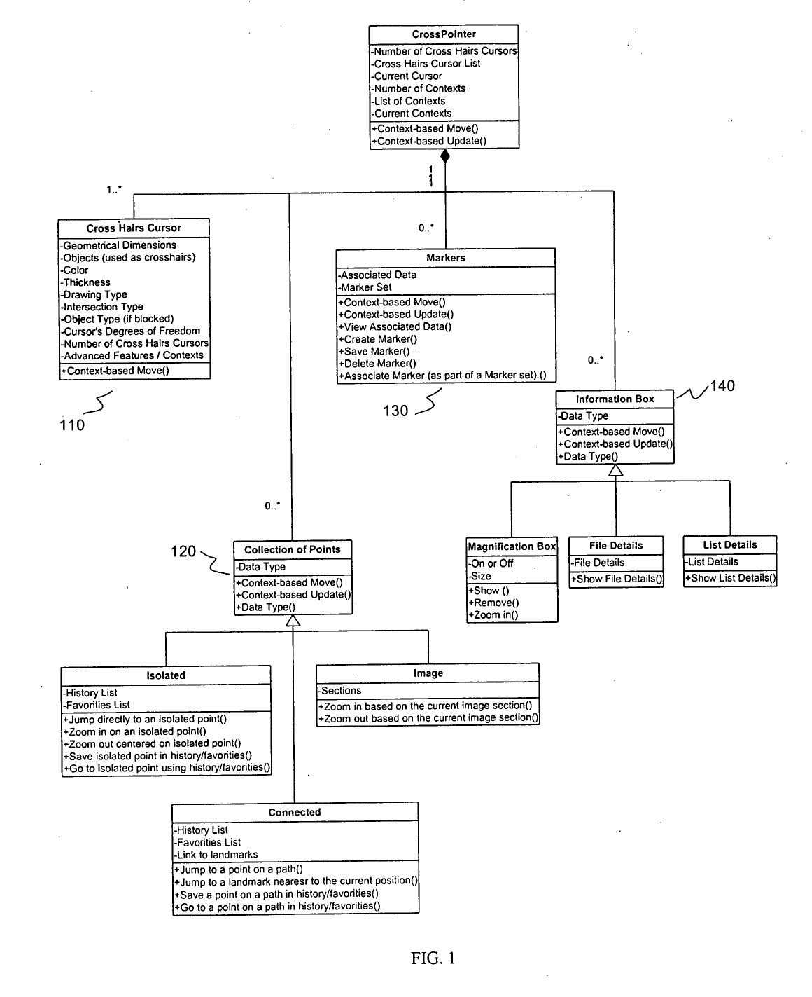

A preferred embodiment of the CrossPointer comprises a preferred Cross Hairs Cursor module 110, along with possibly one or more advanced modules from the following set: a preferred Collection of Points component 120, a preferred Markers component 130, and a preferred Information Box component 140 (collectively, “advanced features components”). See FIG. 1. Adding a preferred Collection of Points component 120 enables a Context-driven Navigation feature. Similarly, adding a preferred Markers component 130 and a preferred Information Box component 140 enables Marker Creation and Information Resolution features, respectively. The preferred Cross Hairs Cursor module 110 uses objects representing different geometrical dimensions to allow a mobile user to easily focus on a given point or region of interest on a mobile device's screen. A number of parameters are associated with the definition of the Cross Hairs Cursor including, but not limited to: (a) the choice of what geometrical dimensions are used; (b) the objects used to represent the geometrical dimensions; (c) the shape, color, and thickness of the chosen objects; (d) whether the objects are drawn fully or only partially; (e) whether the intersection of the objects is blocked or open; (f) the type of object that is used to block the intersection; (g) the degrees of freedom for cursor movement; and (h) the number of Cross Hairs Cursors.

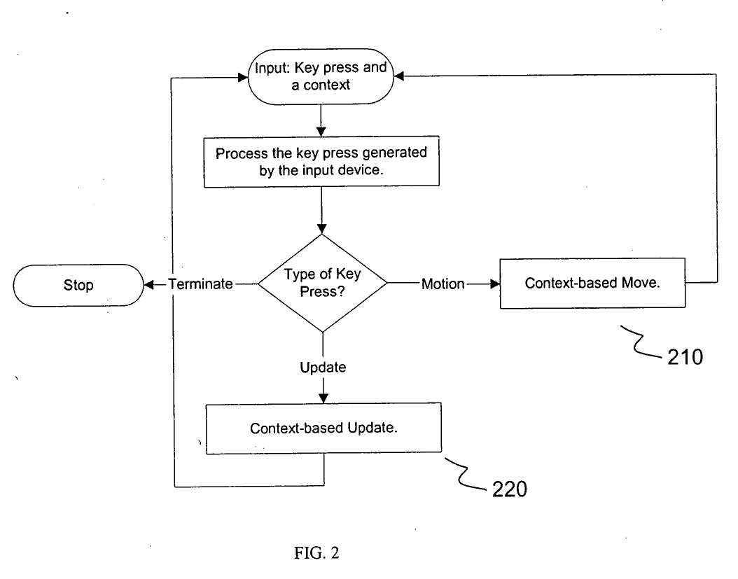

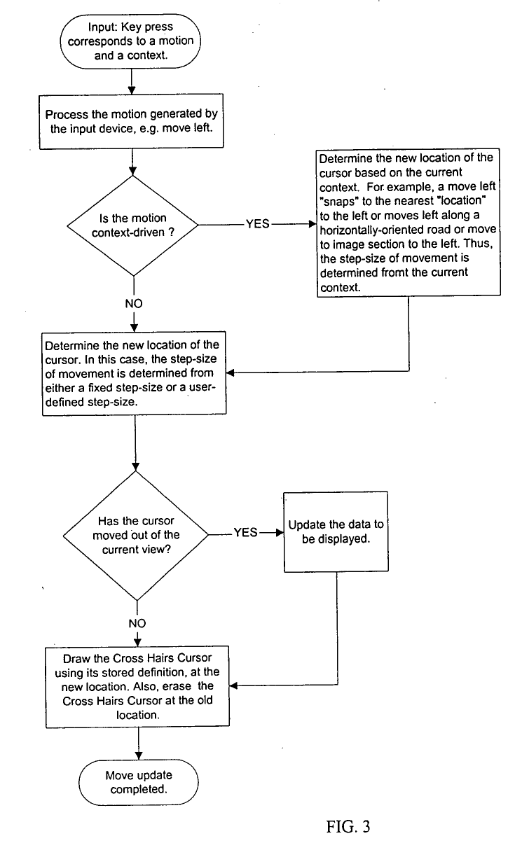

Each of the three advanced features component modules of the CrossPointer preferably has a context or meaning associated with it. In other words, the choice of advanced features components included in a particular implementation of the CrossPointer determines the context(s) associated with that implementation. As a result, events from an input device that are handled by the CrossPointer are classified based on the context and preferably divided into three groups—motion events, update events, and a terminate event. A preferred Context-based Move process 210 handles motion events, while a preferred Context-based Update process 220 handles the update events. See FIG. 2. If one or more of the advanced features components are included, the mode of navigation associated with the CrossPointer is also enhanced. If no context is available (other than the default context, which is the raw data), a motion event is handled by first updating the location of the cursor based on the type of motion event and the step-size (either fixed or user-defined). On the other hand, if a context is available, the new location is determined using the current context's rules for handling motion events. In either case, depending on whether the motion of the cursor moves it out of the current view or not, the data to be displayed may need to be updated. See FIG. 3.

The handling of update events as part of the cursor's activities is one of the more unique advantages of the CrossPointer. Furthermore, the exact type of events and their handling is unique to each context. In a preferred embodiment, three distinct contexts are defined for a preferred Collection of Points component 120, namely Isolated, Connected, and Image. Similarly, three contexts are defined for a preferred Information Box component 140: Magnification Box, File Details, and List Details. Finally, only one context is defined for a preferred Markers component 130: Markers.

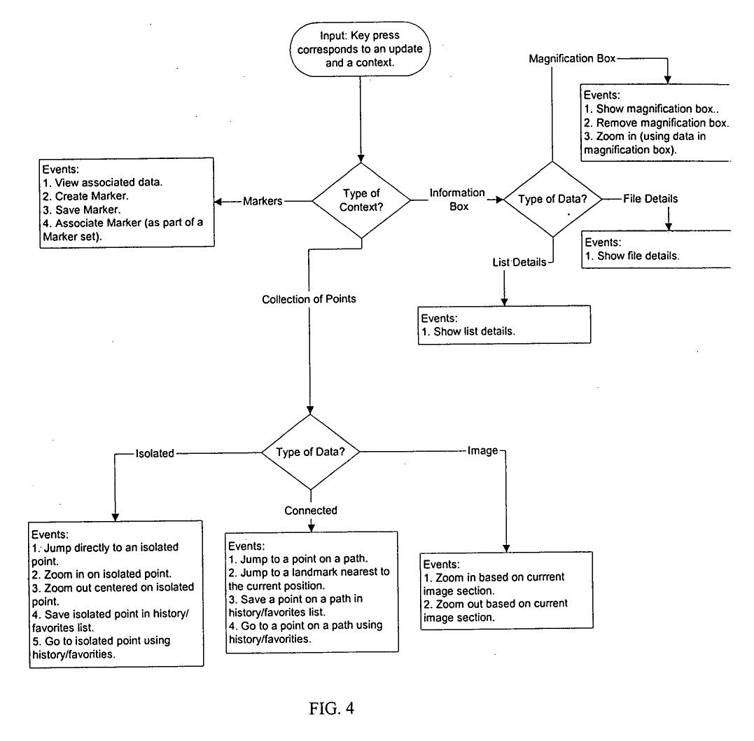

Examples of events associated with each of the seven contexts, and thus handled by the CrossPointer, are shown in FIG. 4. The actual handling of such events generated by an input device may be accomplished using standard event-handling methods. Also, it should be noted that other contexts as well as events for the already defined contexts could easily be incorporated into the CrossPointer.

As used herein, the phrase “discrete set of points” refers to landmarks, markers, and other points that have contexts associated with them. These points may be pre-defined or user-defined. A more detailed description of the Cross Hairs Cursor as well as the preferred advanced features of the CrossPointer is given below.

Preferred Cross Hairs Cursor

The intersection of the Cross Hairs Cursor represents the current cursor position or the point, or region of interest on the screen or window. The movement of the cross hairs is controlled by whatever input device is available, including but not limited to, arrow or directional keys, stylus, number pad, mouse, and/or keyboard. In particular, the Cross Hairs Cursor preferably can be controlled using only four motions (up, down, left, and right) on the screen. This may be implemented by mapping these motions to four keys on the number pad (for example, the keys: “8 ”, “2 ”, “4 ”, and “6”) or to four corresponding directional keys. As a straightforward extension, four additional motions can be added to support movement in the four diagonal directions: up-and-left, up-and-right, down-and-left, and down-and-right.

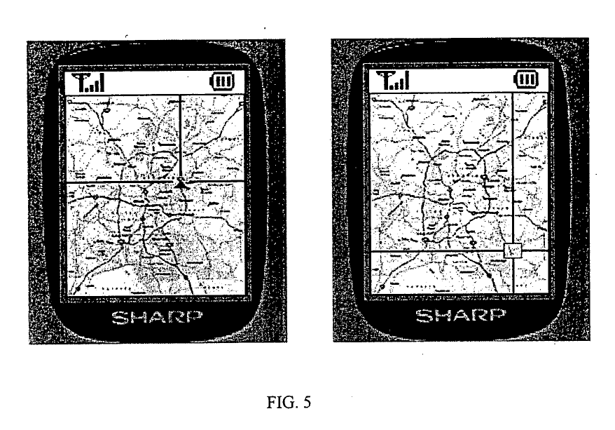

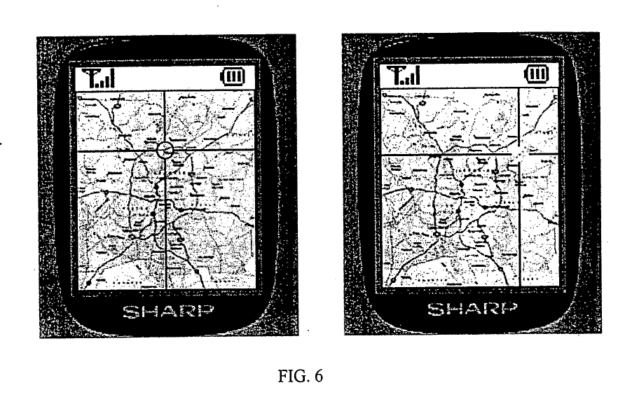

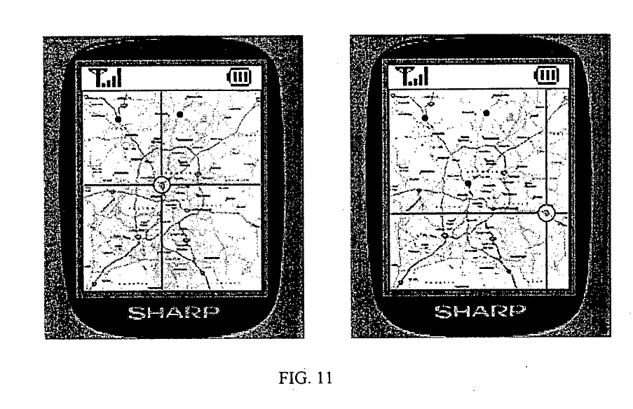

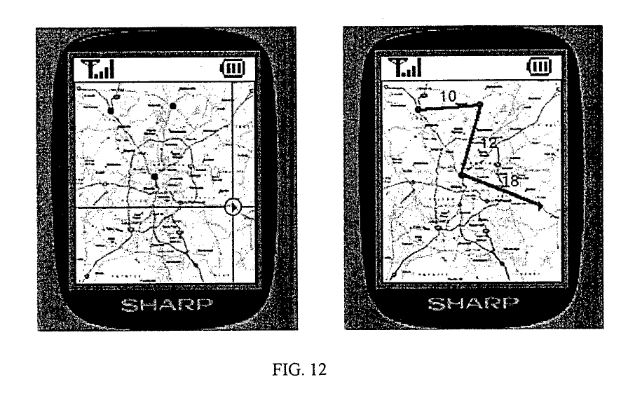

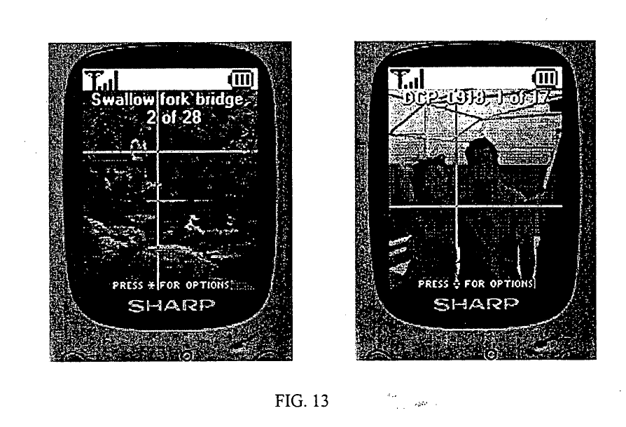

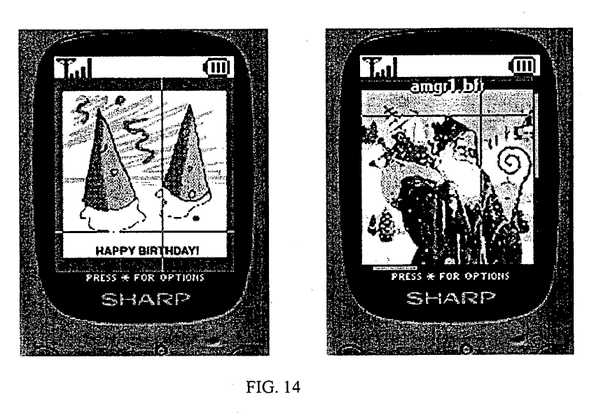

A pair of intersecting lines drawn perpendicular to each other can be used to represent the Cross Hairs Cursor. Using our natural ability to track along straight lines, our eyes are drawn to the center of the cross hairs without focusing attention. This is particularly important for the mobile user, especially where the viewing environment is unstable. The color and thickness of the cross hairs can also be set so that the cross hairs are easier to see. In a similar vein, the lines representing the hairs can be only partially drawn (or visible). For example, the portions drawn (or visible) can be in the region near the intersection of the cross hairs, can exclude the region near the intersection of the cross hairs or can exclude part of one of the lines. Another variation of the Cross Hairs Cursor is to block the portion near the intersection, allowing the object of interest to be fully visible. Some of these examples of Cross Hairs Cursors in a map application are illustrated in FIGS. 5-12. Also, the Cross Hairs Cursor can be used on many types of data, including but not limited to, maps, pictures, and graphics (see FIGS. 5-15).

The Cross Hairs Cursor may be drawn using objects other than lines. An object of the Cross Hairs Cursor is to enable a user to quickly focus or locate the intersection of the objects. A theme-based version of the CrossPointer based on an “Icicle” theme may use icicles instead of the lines with an ice cube drawn in the center of the intersecting icicles to help the user focus on a particular data item on the device's display. In another theme-based version of the CrossPointer based on a “Hunter” theme, the two lines are replaced with inward pointing arrows and a shooting target is drawn in the center region.

In special situations, more than one Cross Hairs Cursor may be used. Consider a map application with a Cross Hairs Cursor navigational device. One Cross Hairs Cursor allows the user to navigate around the cities (landmarks) on the map and another Cross Hairs Cursor assists the user in defining a rectangular-shaped zoom region on the screen. Once the rectangular region is defined, the contents of the map within the rectangular region are zoomed in an extra level.

A current position can be displayed in pixel coordinates or map coordinates and the cross hairs can be repositioned by directly entering the new coordinates. The movement of the CrossPointer's cursor can be that of a standard cursor, with only two degrees of freedom (horizontal and vertical) or its movement can be dependent on a particular context. In other words, the CrossPointer can be either in the default navigation mode or the context-driven navigation mode and is capable of switching between the two navigation modes. It should be noted that the context-driven navigation mode is an advanced feature of the CrossPointer and not all implementations of the CrossPointer need to support this mode.

The Cross Hairs Cursor can be implemented by drawing a horizontal line and a vertical line across the height and width of the screen through the location of the cursor. The location of the CrossPointer is the point of intersection of the cross hairs. The color and thickness of these lines can be fixed or varied depending on a number of factors, including, but not limited to, the user's preferences, the data being displayed, and the colors used to display the data. Another option is to either draw the lines completely across the screen or only draw them in an area close the intersection of the cross hair.

Navigation of the cursor is implemented in three steps: first, by processing motion events generated by the input device; second, by determining the new location of the cursor from the events; and finally, by drawing the cursor at the new location. The information contained in a motion event is either the new location of the cursor or a movement relative to the current location (for example, an upward movement indicated by the pressing of the up key). In the latter case, the new location is calculated using the direction and step-size of the movement. The step-size of a movement is the amount the cursor moves each time a motion event occurs and can be implemented using many methods, including, but not limited to, a pre-determined step-size, a step-size relative to the screen's dimensions or the data's dimensions (if applicable), a user-defined step-size, and a continuously changing step-size depending on the resolution of the data being displayed (in this case, the notion of resolution must be part of the data's properties). Before the cross hairs that form the CrossPointer are drawn at the new position, the old pair of cross hairs must be erased. A number of well-known computer graphics techniques exist that may be used to draw or erase cross hairs.

Preferred Context-Driven Navigation

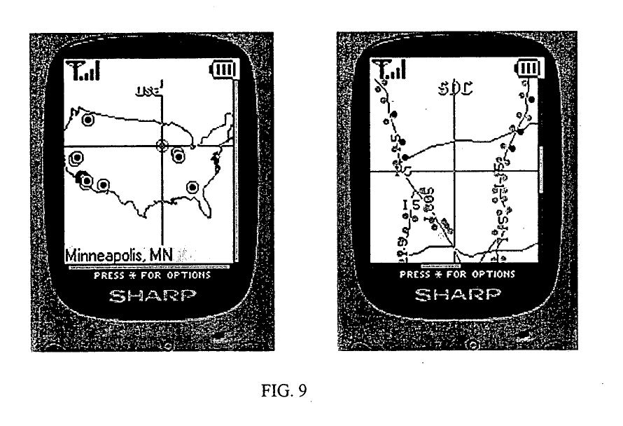

In the default mode described in the previous section, the navigation of data using the CrossPointer is implemented by updating the Cross Hairs Cursor to move to a new location each time a new movement is indicated by the input device. The new location's coordinates are either explicitly entered by the user or calculated from the previous location of the Cross Hairs Cursor and the implicit movement (for example, an upward movement indicated by the pressing of the up key). In more advanced navigation modes, the behavior of the CrossPointer navigation may depend on one or more contexts (see FIG. 9).

One advantage of context navigation is that one can quickly access points of interest on certain screens, when the input device is the directional keypad (arrow keys). Navigating the points should occur in a natural way. For instance, if the path is a set of isolated points, then when you press the up arrow the CrossPointer jumps to the closest marker above the current cursor position. If the path is a connected set of data points, the user can move the CrossPointer along the path and, at the junction of two or more paths, the user can choose to continue along any one of the possible directions.

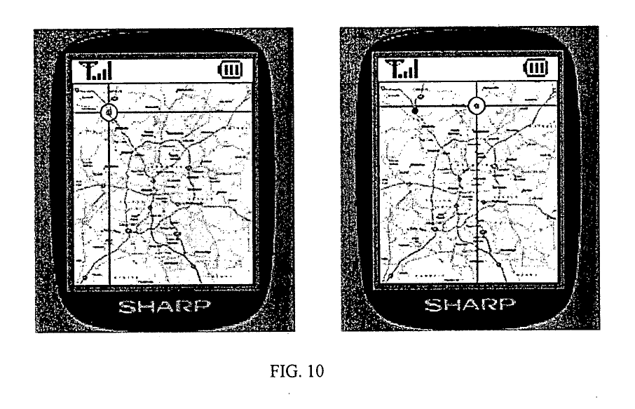

In both examples in the previous paragraph, the context is determined by the application. The isolated or connected points contain information that associates them with other isolated points or connected points, respectively. A different kind of context of the data is that defined by a user. For instance, a user working with a map application may create a travel route on the map by selecting locations of cities on the device's display. The first city chosen forms the first entry in this user-defined context, the second city chosen forms the second entry in the user-defined context, and so on. The point is that the user decides the order of cities and thus navigation among the cities in this user-defined context is based on user-defined ordering. The user uses the forward and back keys on his device to move along the path. Also, a link between the cities chosen by the user can be approximated by the map application, even when there is no actual road connecting the chosen cities. Travel times between the cities and distances between the cities may also be calculated and displayed on the device's screen. This example is illustrated in FIGS. 10-12.

Below, some examples of context-driven CrossPointers and preferred properties associated with each context-driven CrossPointer version are described. Note that each of the following examples is an extension of the basic CrossPointer.

### EXAMPLE 1

### Navigating Landmarks on a Map (a Set of Isolated Points)

Consider the following user scenario. The user opens up a mapping application on his mobile device and requests a map of a city that he is planning to visit. Being unfamiliar with the city, he wants to find a hotel close to the airport. The mapping application has an option to show all hotels as landmarks superimposed on top of the map of the city. Suppose that while he is browsing the region around the airport, he finds a hotel to the west of the airport and wants to check whether there is another hotel between the one he found and the airport. Due to the small screen size, the map application is not able to display both hotels that he found and the airport at the same. If the application has support for only simple navigation, he needs to move the map eastward toward the airport, searching for another hotel as he does. A preferred navigation mode is to directly allow the motion of the cursor to be tied to the context of the data being displayed.

In this case, the current context is not the streets of the city but the hotels (landmarks). In the context-driven mode, the CrossPointer simply moves to the next hotel east of the hotel that has already been found. Hotels form just one category of landmarks. Other categories are restaurants, tourist sights, government buildings, grocery stores, malls, shops, gas stations, religious buildings, recreational parks and centers, apartment complexes, schools, universities, geographical features like mountains, valleys, waterfalls, lakes, streams, rivers, seas, oceans, and many others including user-defined categories.

Now, once the user finds the hotel of his choice, he wants to take a closer look at the area around the hotel, possibly to determine the names of the streets near the hotel. The user presses a zoom-in key and a zoomed-in version of the map is generated, with the hotel (landmark) placed at the center of the screen.

The following are some of the properties of the context-driven CrossPointer highlighted by this example:
(i) The landmarks are specified by a list containing coordinates and other data.
(ii) The CrossPointer snaps to the landmarks.
(iii) The CrossPointer is implemented so that it jumps naturally between landmarks—for instance, if you press the up arrow the CrossPointer jumps to the closest landmark above the current landmark.
(iv) The CrossPointer allows discrete settings, or in other words, the cursor can be moved to only a discrete set of locations (the landmarks). For the user, this means that the visual feedback is minimized.
(v) The user is given the option to override the default definitions of the different movements (from one landmark to another) that are supported by the CrossPointer.
(vi) Zoom operation centered at the current landmark. If the user is on a landmark and presses the zoom-in key (or the zoom-out key, a new view of the map is generated with the chosen landmark at the center of the view.
(vii) A history of landmarks or “paths” of landmarks visited can be maintained.

As mentioned above, the information about the landmarks is stored. as a list containing coordinates and other data relevant to the specific landmark (for example, a title). A default navigation mode is set up depending on a number of factors, including, but not limited to, type of data and the input device, so that the movement from one landmark to another is uniquely defined. For example, if the input device has only two keys, a front key and a back key, the default navigational mode could order the landmarks in row-major format, so that the first landmark is the one that is the one most towards the top-left portion of the screen and the last landmark is the one most towards the bottom-right portion of the screen. In a more general setting, the user can be given the option to move directly to the third landmark by pressing the “3” key or move to a landmark starting-with one of the letters “a”, “b”, or “c” by pressing the “2” key. The user is given the option to override the default navigational mode. The history of the landmarks visited is also stored as a list.

### EXAMPLE 2

### Navigating from a History Log

As mentioned above, the CrossPointer can be repositioned either directly by entering new coordinates or implicitly by generating a motion using an input device. The CrossPointer stores a history of the locations visited by a user. The user can now easily go back to any of the locations in the CrossPointer's history log or list. Also, the user can traverse through only the locations in the history list without having to browse the entire data set. In effect, the entries of the history list form another type of landmark.

There are three types of locations that can be stored in a history log. The first type includes each and every location visited by the CrossPointer, including temporary points, such as points on which the CrossPointer is positioned for a very short duration. The second type includes only those points at which the CrossPointer is positioned for a time interval greater than a specified time interval. Another option is to allow the user to mark a particular location as a significant location. Significant locations form the third type of location. The locations in the second and third types can be considered to be the Points-of-Interest of the user. The history log using locations from the first type tends to fill up quickly and as a result, the history log may start to overflow. Also, only a fraction of the locations have some significant meaning to the user. Thus, a smaller history log containing more relevant locations (to the user) is maintained if only locations of the Points-of-Interest are entered into the history log.

In this example, the-following context-driven navigation properties of the CrossPointer are described:
(i) The CrossPointer may be positioned from a history log or list.
(ii) The history log or list may be constructed using locations of the first, second, or third types of locations.

The history log preferably is implemented as a list.

### EXAMPLE 3

### Navigating Roads on a Map (a Connected Set of Points)

Consider the following modification to the user scenario in Example 1. The user is driving with a friend and they are lost. They want to find their way back to the nearest highway or street that they are familiar with. The user opens up his map application armed with the context-driven CrossPointer and a location-based service, such as GPS (Geographic Positioning System). Immediately, based on his geographic location, the map application displays a map of the region he is in and centers the CrossPointer at his current location. The user can then use the directional keys to follow the road in a direction of his choice. Using the directional keys, he traces a route that initially seems to take him in the right direction but that actually takes him in the opposite direction. He snaps the CrossPointer to the starting location and tries an alternative route in the opposite direction. Once the preferred route has been isolated, the system adds it to the history log for future reference.

Mapping the directional keys to movements along a road can be implemented in one of several ways. In one embodiment, for the sections of roads without intersections, the mapping of directional keys can be determined using the orientation of the road (for example, if the road was oriented in the vertical direction, the up and down keys can be used). Since most intersections (of roads) have less than nine branches, the eight directional keys or the numeric keys can be used to implement the different navigational options. Another method is to include a forward key and a backward key (and possibly, other keys) that move the cursor in the forward and backward directions, respectively, along the road.

In this embodiment, CrossPointer follows the roads instead of simply moving sections of the map. The user gets precise control of his movements and can easily trace his path. Also, the CrossPointer can build a history log of locations as the path is traced, easily allowing the user to go back to any point on the path. Now, along the way, his friend tells him that they need to find a gas station. Since the CrossPointer is following the route taken by the user, the map application highlights the nearest gas station (a landmark) and the CrossPointer snaps to the new location.

The following are some of the properties of a preferred context-driven CrossPointer highlighted by this example:
(i) The mapping of movement along a path to the directional or arrow key is made either automatic or semi-automatic. It requires only the up or right arrow to move right along. an upwardly slanted path and the mapping to the arrow key is automatically performed.
(ii) The CrossPointer can be used with location information to track one's position on a map.
(iii) The CrossPointer keeps a history log or list that allows the user to revisit any previous location on a path. A more advanced option is to allow the user to select a preferred path from the history list.
(iv) The CrossPointer can be used to select the nearest landmark to one's position.

### EXAMPLE 4

### Navigating an Image by Sections

Consider an image viewing application with zoom and pan capability. Typically, zooming in and out are controlled by the input device. For instance, if the application is in zoom mode, then, starting at an initial view of an image, clicking on the left button of a computer mouse may zoom in the view by one level and clicking on the right button of a mouse may zoom out the view by one level. Also, the image zoom is performed at the position of the cursor or arrow. Most mobile devices do not have a computer mouse as an input device and, as a result, the zoom option of an image viewing application needs to be controlled through some other input device. For instance, the numeric keypad can be used for this purpose, pressing the zoom-in key corresponding to the zooming-in operation on an image and pressing the zoom-out key corresponding to the zooming-out operation on an image.

A preferred context-driven CrossPointer supports region-based zoom of an image. An image is divided into regions defined by the CrossPointer. These regions can be: (a) regular-sized and regular-shaped tiles of the image (for instance, dividing the image into a 9×9 grid or into 81 tiles); (b) irregular shapes divided through some region splitting method; or (c) arbitrarily chosen shapes defined by the image viewing application or the user or sets of attributes (such as edges, colors, or textures). The image can be navigated by moving quickly from one region to another, based on the location of the CrossPointer for each region and mapping of movements of the CrossPointer to the input device events, depending on the image viewing application. For instance, the image can be divided into a 9×9 grid with the location of the CrossPointer at the center of the tile, and the image viewing application can map the movements of the CrossPointer to the directional keys (up, down, left, and right), such that pressing of a directional key moves the CrossPointer to the corresponding neighboring tile. Two other keys (for example, the zoom-in key and the zoom-out key) are mapped to zooming in and out movements. The zoom movement is centered on the tile on which the CrossPointer is located. Also, the tiling is recursively applied to each tile as that tile is zoomed in on, up to some practical resolution limit. The main extension to the basic implementation of the CrossPointer is the division of the screen into regions based on one or more of the definitions described above. Information about each region preferably is stored either in a list or an array for easy access by the CrossPointer. The data preferably supports zooming and panning.

In this example, the following context-driven navigation properties of the CrossPointer are described:
(i) An image may be navigated by selecting the centers of sector grids, including, but not limited to, quadrants and tiles and then zooming that sector to full screen.
(ii) Motion to the sectors or regions is quantized for quick image navigation.
(iii) Sectioning of the data based on attributes of the data such as edges, textures, or colors, and not on the sections or regions of the display.

Preferred Marker Creation

Markers are locations on the display that have associated bits of accessible data. On the display, the marker is represented as an icon with an optional label. When the CrossPointer is on a marker, the data associated with that marker can be viewed. Marker sets can be generated by an application. For example, the locations of hotels, restaurants, and movie halls for a particular city can be generated as markers by a mapping application. Markers can also be created and saved by the user. Users may set a marker's icon, label, and data, creating their set of personalized markers. Once created, these markers can be used as bookmarks—as points of interest that the user can return to or reference quickly. Cross hairs are attached to a marker to make the marker easily visible. Navigation between markers is identical to the context-driven navigation for a set of isolated points described above. As mentioned above, both markers and landmarks are in the category of “discrete set of points,” meaning that they are points to which context is associated. The major difference between markers and landmarks is in the information content associated with points. The information content associated with a marker can vary from one marker to another, while all landmarks in the same set usually contain the same kind of data. As a result, the list defined for markers comprises a generic data structure so that different types of markers can be supported by the list.

Preferred Information Resolution

Information resolution is a method to give users a way to access, retrieve, and view additional information content related to data currently pointed to by the CrossPointer. The CrossPointer points to specific data when the intersection of the cross hairs lies on top of the data. This additional information is usually displayed on the screen using a “pop-up” window or an information box. The information box allows extra information to be displayed on top of the current screen contents. Below are a few examples of data that can be displayed in an information box:

### EXAMPLE A

### Image Magnification Box

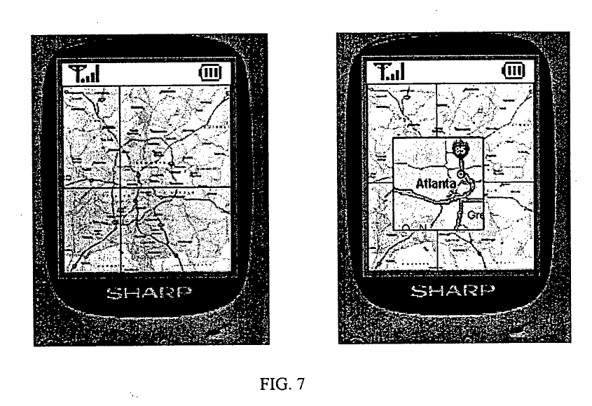

The magnification box can display an image at a different (usually higher) resolution centered at the current CrossPointer location. While activated, the magnified region follows the cross hairs intersection. The magnification box helps avoid zooming and it allows the higher resolution area to be seen in context of the larger image. The magnification box size and resolution level preferably can be set by the end-user. The image magnification routine then generates an image of the magnification box size and resolution level, centered at the location of the CrossPointer (see FIG. 7).

### EXAMPLE B

### View More Details in a Street Map

The information box can bring in street names or more details of the street map, not necessarily magnifying the information box area, or it can bring in a completely different aspect of the detail area. A few examples of such information are:
(i) A telephone number of a restaurant (landmark).
(ii) A zoomed-in view of a map centered at the CrossPointer's location.
(iii) A more detailed view at the same magnification of a map centered at the CrossPointer's location.
(iv) A picture of a house for sale.

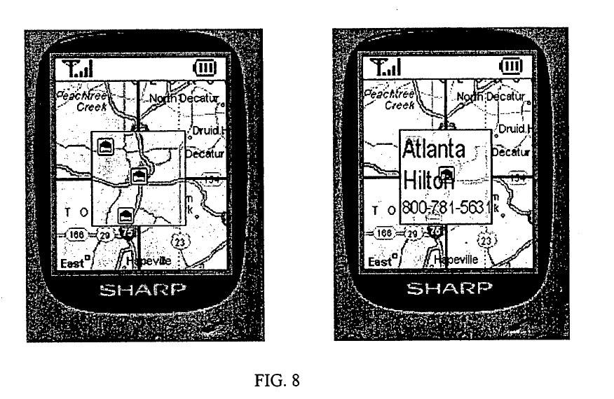

The information displayed in the information box preferably is stored along with the street map data. Once the additional information is retrieved, it is displayed in the information box with a font—style, color, and size—chosen either by the application or the user (see FIG. 8).

### EXAMPLE C

### Data from a Contact List

Specified data (such as a phone number) may appear in the information box when the CrossPointer is over a name in a contact list.

The specified data preferably is either available along with the data being navigated or is retrieved from another source of information. A more complicated series of steps may be necessary to retrieve this data from the other information source. For instance, a name-based search on the data file with the contact list or a connection to a known server on some network where the rest of the information associated with the contact list resides may be required (see FIG. 8).

In summary, even though the information box can be used as a display magnifier, it is not a magnifying glass in the usual sense, since it can bring in data that is not on the original display; in fact, magnification of the underlying data may not even make sense—for example, if the data were a text document.

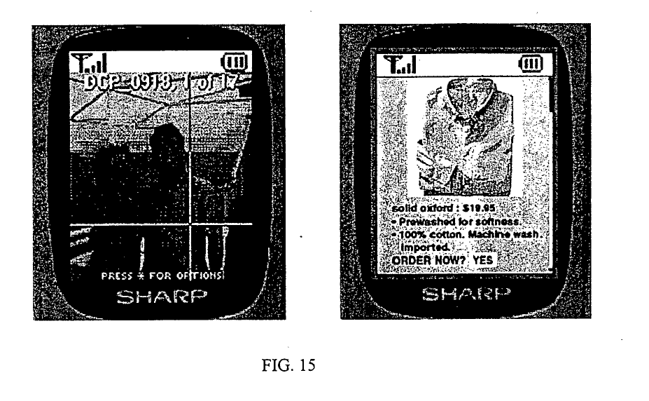

As the examples above illustrate, the information box typically is used to display requested information that is related to the screen content and current cursor position. However, this is not necessary—the information box can be used as a window into another world or information domain. For instance, the information box may open up a view into another application. An image viewing application may allow the creation of image maps—pictures with regions that contain links to other applications. For example, a picture could include a celebrity wearing a shirt and the shirt could be a region with a link to an e-commerce application. When the user positions the CrossPointer on the shirt and clicks on the select key, the e-commerce application brings up the details about the shirt, including the designer's name, price, sizes, colors, patterns, washing instructions, and shops or web-sites where the shirt is available (see FIG. 15).

Two options can be set up along with the information box. In the first option, the user is able to change the addressed information content within the information box—for example, change the requested information, or increase or decrease the level of detail. In the second option, the cross hairs are drawn on top of the information box.

The CrossPointer comprises a physical interpretation (the Cross Hairs Cursor) as well as a methodology or a process highlighted by its advanced features. That is, the Cross Hairs Cursor is more than crosshairs. Some of the unique features of the Cross Hairs Cursor are the flexibility of what constitutes a “line,” what constitutes an “intersection,” and what geometrical dimension the objects represent; the ability to have more than one cursor, and the adaptation of the cursor to the mobile user.

But the CrossPointer is more than this navigational tool for maps, images, text, etc. The Cross Hairs Cursor makes it easy to locate a point of interest by pointing the intersection of the cross hairs to the specific data and controlling the movement of the cross hairs by arrow keys, stylus, and/or other input devices.

Through the use of its advanced features like context-driven navigation, marker creation, and information resolution, the CrossPointer defines a unique and novel methodology. Using the Cross Hairs Cursor, the user is able to quickly locate a region or item of interest, using a minimum of input devices like a 4-key navigational keypad. A context or meaning is associated with the data being navigated. According to the context, the CrossPointer defines advanced capabilities. For instance, if the context comprises a discrete set of points, the user can use the CrossPointer to navigate from one point to another using the same 4-key navigational keypad. The user may also be able to access additional information about the current point by pressing another key. If the context is image data (e.g., a street map, graphic, or picture), along with the 4-key navigation (pan), the CrossPointer may facilitate zoom in and out, centered around the location “pointed to” by the CrossPointer. These examples illustrate only context-driven navigation. Other advance capabilities are supported by the CrossPointer—marker navigation and information resolution.

Thus, aspects of the present invention include: a system and method to navigate, as well as access, retrieve, and view data (or a portion of the data) displayed on the entire screen of a device or in a portion of the screen; using a Cross Hairs Cursor that consists of intersecting objects, each object corresponding to a different geometrical dimension of the screen; and indicating the position of the cursor in that dimension.

Furthermore, the objects may be chosen so as to enable the user to quickly focus on or locate a specific point on the display that is the region-of-interest of the Cross Hairs Cursor, to minimize the time to search the device's screen for the Cross Hairs Cursor.

The invention, in another aspect, includes a system and method wherein the intersection of the cross hairs points to the current region-of-interest on the device's screen, such a region being defined by either the user or the application, where an input device controls the movement of the cross hairs.

Furthermore, multiple Cross Hairs Cursors can be used, and it is possible to turn the cross hairs on and off.

In another aspect, the invention comprises a system and method wherein the Cross Hairs Cursor consists of a pair of intersecting lines that are drawn perpendicular to each other. Some portions of the intersecting lines may not be drawn or visible. An icon may be drawn to highlight the intersection of the lines, or an object may be drawn to enclose a region around the intersection of the lines, or the region may be left empty.

In a further aspect, the invention comprises a system and method wherein the data or a portion of the data displayed on the device has associated with it a meaning, or context, and the navigation of the Cross Hairs Cursor through the data is based upon the context of the data. The context of the data may be defined by using, but not limited to: data files; image files; algorithmic descriptions; and locations on the screen chosen by the user.

In a still further aspect, the invention comprises a system and method wherein the context of the data is based on a discrete set of points, or landmarks, and the intersection of the cross hairs is automatically positioned to the nearest landmarks, the movement of the cursor between landmarks is defined naturally, and can be controlled by a simple input device, including but not limited to a directional keypad and a numeric pad, and a history of landmarks visited is maintained. The nearest landmark may be defined in anyone of many ways, including but not limited to: spatial proximity; temporal proximity; or based on some attribute of or relationship between the landmarks. “Spatial proximity” refers to how much distance one has to travel to get from one landmark to the next; “temporal proximity” refers to how long it takes to travel from one landmark to the next.

In another aspect, the invention comprises a system and method wherein the context of the data is based on a connected set of points, or roads or curves; and the intersection of the cross hairs is positioned only on this connected set of points. The movement along roads is either automatic or semi-automatic, and can be controlled by a simple input device, including but not limited to: a directional keypad; a pointing device; or a numeric pad; the user's location can be interpreted from the position of the intersection of the cross hairs. This information can be used to track the user's position; the nearest landmark to any point on the road can easily be located; and a history of points visited is maintained for later recall and use.

In a further aspect, the invention comprises a system and method wherein the context is image data that is divided into sections or regions; the intersection of the cross hairs can only be positioned at pre-defined locations within the regions; movements in three-dimensions are in the form of panning between regions in two dimensions; and zooming within a region in the third dimension is supported.

In another aspect, the invention comprises a system and method wherein the data or a portion of the data displayed on the device has associated with it more than one context (as described above); and the system has the ability to switch from context to another.

In another aspect, the invention comprises a system and method wherein the data is in the form of markers or locations on the display that have associated icons, labels, and other accessible data and can be defined in any one of multiple ways, including, but not limited to by an application or by a user; and a history of markers is maintained for later recall and use.

In a further aspect, the invention comprises a system and method wherein an information resolution method (that is, a method to access, retrieve, and display additional data on the screen related to the data pointed to by the intersection of the cross hairs) supplements the basic data navigational system. Furthermore, this additional data may be displayed in a “pop-up” window or information box.

Although preferred embodiments of the present invention have been disclosed for illustrative purposes, those skilled in the art will appreciate that various modifications, additions and substitutions are possible, without departing from the scope and spirit of the invention as recited in the accompanying claims.

What is claimed is:

1. A method for providing a navigable, context-sensitive electronic display, comprising:
providing a cross hairs that consists of objects forming an intersection, each object corresponding to a different geometrical dimension of the display;
communicating with an input device that provides signals to control movement of said cross hairs; and
in response to signals received from said input device, configuring said cross hairs to point to a region on said display;
wherein at least some data displayed on said display has an associated context; and
wherein movement of said cross hairs on said display is based at least in part upon said context.

2. A method as in claim 1 wherein the context of the data relates to one or more of the following:
data files;
image files;
algorithmic descriptions; and
locations on the screen chosen by the user.

3. A method as in claim 1 wherein said movement comprises zooming in and zooming out.

4. A method as in claim 1 wherein clicking or otherwise activating said cross hairs causes additional, context-based data to be displayed.

5. A method as in claim 1 wherein the context of the data relates to a discrete set of points.

6. A method as in claim 5 wherein said discrete set of points comprises landmarks.

7. A method as in claim 5 wherein said discrete set of points comprises markers.

8. A method as in claim 5 wherein the cross hairs are automatically positioned to the nearest point in said discrete set of points.

9. A method as in claim 5 wherein a history of points in said discrete set of points to which said cross hairs has been previously positioned is maintained.

10. A method as in claim 8 wherein the nearest point in said discrete set of points is defined in terms of spatial proximity.

11. A method as in claim 8 wherein the nearest point in said discrete set of points is defined in terms of temporal proximity.

12. A method as in claim 1 wherein the context of the data relates to a set of points linked by one or more paths.

13. A method as in claim 12 wherein the cross hairs are positioned only on points within said set of points linked by one or more paths.

14. A method as in claim 13 wherein movement along said set of points linked by one or more paths is controlled by an input device.

15. A method as in claim 1 wherein the context of the data relates to image data that is divided into regions.

16. A method as in claim 15 wherein the cross hairs can only be positioned at pre-defined locations within said regions.

17. A method as in claim 1 wherein at least some displayed data is associated with more than one context, and further comprising enabling a user to switch from one context to another.

18. Software for providing a navigable, context-sensitive electronic display, comprising:
software for providing a cross hairs that consists of objects forming an intersection, each object corresponding to a different geometrical dimension of the display;
software for communicating with an input device that provides signals to control movement of said cross hairs; and
software for configuring said cross hairs to point to a region on said display in response to signals received from said input device;
wherein at least some data displayed on said display has an associated context; and
wherein movement of said cross hairs on said display is based at least in part upon said context.

19. Software as in claim 18 wherein the context of the data relates to one or more of the following:
data files;
image files;
algorithmic descriptions; and
locations on the screen chosen by the user.

20. Software as in claim 18 wherein said movement comprises zooming in and zooming out.

21. Software as in claim 18 wherein clicking or otherwise activating said cross hairs causes additional, context-based data to be displayed.

22. Software as in claim 18 wherein the context of the data relates to a discrete set of points.

23. Software as in claim 18 wherein the context of the data relates to a set of points linked by one or more paths.

24. Software as in claim 18 wherein the context of the data relates to image data that is divided into regions.

25. Software as in claim 18 wherein at least some displayed data is associated with more than one context, and further comprising software for enabling a user to switch from one context to another.
